(19) United States
(12) Patent Application Publication
(10) Pub. No.: US 2024/0070503 A1
(43) Pub. Date: Feb. 29, 2024

(54) HIGH-LOAD VERTICAL CRYOGENIC NANOPOSITIONER

(71) Applicant: IonQ, Inc., College Park, MD (US)

(72) Inventors: Nadir SHAH, Reston, VA (US); Sarah Margaret KREIKEMEIER, San Diego, CA (US); Kai Makoto HUDEK, Hyattsville, MD (US)

(21) Appl. No.: 18/145,677

(22) Filed: Dec. 22, 2022

Related U.S. Application Data
(60) Provisional application No. 63/292,971, filed on Dec. 22, 2021.

(51) Int. Cl. G06N 10/20

(52) U.S. Cl. CPC G06N 10/20

(57) ABSTRACT

Aspects of the present disclosure relate generally to systems and methods for use in the implementation and/or operation of quantum information processing (QIP) systems, and more particularly, to the implementation and use of a quantum information processing (QIP) system including one or more vertical nanopositioners configured to reposition one or more components coupled to the nanopositioner and weighing between about 1 kilogram (kg) and about 5 kgs. The one or more vertical nanopositioners may be positioned in the cryogenic environment.

### CROSS-REFERENCE TO RELATED APPLICATION

This application claims the benefit of U.S. Provisional Patent Application No. 63/292,971, filed Dec. 22, 2021 and hereby incorporates by reference herein the contents of this application.

### TECHNICAL FIELD

Aspects of the present disclosure relate generally to systems and methods for use in the implementation and/or operation of quantum information processing (QIP) systems.

### BACKGROUND

Trapped atoms are one of the leading implementations for quantum information processing or quantum computing. Atomic-based qubits may be used as quantum memories, as quantum gates in quantum computers and simulators, and may act as nodes for quantum communication networks. Qubits based on trapped atomic ions enjoy a rare combination of attributes. For example, qubits based on trapped atomic ions have very good coherence properties, may be prepared and measured with nearly 100% efficiency, and are readily entangled with each other by modulating their Coulomb interaction with suitable external control fields such as optical or microwave fields. These attributes make atomic-based qubits attractive for extended quantum operations such as quantum computations or quantum simulations.

It is therefore important to develop new techniques that improve the design, fabrication, implementation, operation, and/or control of different QIP systems used as quantum computers or quantum simulators, and particularly for those QIP systems that handle operations based on atomic-based qubits.

### SUMMARY

The following presents a simplified summary of one or more aspects to provide a basic understanding of such aspects. This summary is not an extensive overview of all contemplated aspects and is intended to neither identify key or critical elements of all aspects nor delineate the scope of any or all aspects. Its sole purpose is to present some concepts of one or more aspects in a simplified form as a prelude to the more detailed description that is presented later.

This disclosure describes various aspects of the implementation and operation of a vertical nanopositioner for use with high loads and in cryogenic environments in QIP systems.

To the accomplishment of the foregoing and related ends, the one or more aspects comprise the features hereinafter fully described and particularly pointed out in the claims. The following description and the annexed drawings set forth in detail certain illustrative features of the one or more aspects. These features are indicative, however, of but a few of the various ways in which the principles of various aspects may be employed, and this description is intended to include all such aspects and their equivalents.

### BRIEF DESCRIPTION OF THE DRAWINGS

The disclosed aspects will hereinafter be described in conjunction with the appended drawings, provided to illustrate and not to limit the disclosed aspects, wherein like designations denote like elements, and in which:

FIG. 1 illustrates a view of atomic ions a linear crystal or chain in accordance with aspects of this disclosure.

FIG. 2 illustrates an example of a quantum information processing (QIP) system in accordance with aspects of this disclosure.

FIG. 3 illustrates an example of a computer device in accordance with aspects of this disclosure.

FIG. 4 illustrates an example of an exploded vide of a cryo-compatible nanopositioner assembly in accordance with aspects of this disclosure.

FIG. 5 illustrates an example of an upper stage of the nanopositioner assembly of FIG. 4 in accordance with aspects of this disclosure.

FIG. 6 illustrates an example of a lower stage of the nanopositioner assembly of FIG. 4 in accordance with aspects of this disclosure.

FIG. 7 illustrates an example of a top view of the nanopositioner assembly showing in accordance with aspects of this disclosure.

FIG. 8 illustrates a cross sectional view of the nanopositioner assembly taken at line 8-8 of FIG. 7.

FIG. 9 illustrates a cross sectional view of the nanopositioner assembly taken at line 9-9 of FIG. 7.

### DETAILED DESCRIPTION

The detailed description set forth below in connection with the appended drawings or figures is intended as a description of various configurations or implementations and is not intended to represent the only configurations or implementations in which the concepts described herein may be practiced. The detailed description includes specific details for the purpose of providing a thorough understanding of various concepts. However, it will be apparent to those skilled in the art that these concepts may be practiced without these specific details or with variations of these specific details. In some instances, well known components are shown in block diagram form, while some blocks may be representative of one or more well-known components.

Some QIP systems may be implemented using cryogenic environments (e.g., cryostat or cryogenic chamber) to improve operational performance. One example is for operations to be performed at environments of having temperatures of approximately 4 Kelvin. Environments having temperatures of approximately 4 Kelvin can be achieved by having one or more stages. For example, the cryogenic environment may include a first stage or first environment at 40 Kelvin, and a second stage or second environment within the first stage at 4 Kelvin. Other implementations with more than two stages are also possible.

Some QIP systems that use trapped ions as qubits may deploy the ions inside the cryogenic environment. This cryogenic environment or chamber may also include other components used in the operation of the QIP system. In some instances, components inside the cryogenic environment (e.g., optical components) may need to be moved or aligned for optimal operation of the QIP system. In such instances, positioners such as nanopositioners or nanopositioning stages, are used to provide the needed motion or alignment. This motion or alignment may also be used to compensate or adjust for vibrations that may occur because of the cryogenic environment.

Precision motion at cryogenic temperatures, however, is typically limited to low weight (e.g., 200 g or less) components, and/or has poor mechanical precision (e.g., cannot accurately position components at distances smaller than 5 microns (μm) and/or having a resolution of smaller than 1 μm). To have precision and stability at the nanometer scale, positioners must be rigid and have stable dynamic performance. Additionally, achieving absolute positioning data from conventional positioners on the nanometer level is not possible with the resistive linear sensors used in most commercial products. As used herein, the phrase “absolute position or absolute positioning” means positions that are determined relative to a fixed reference point.

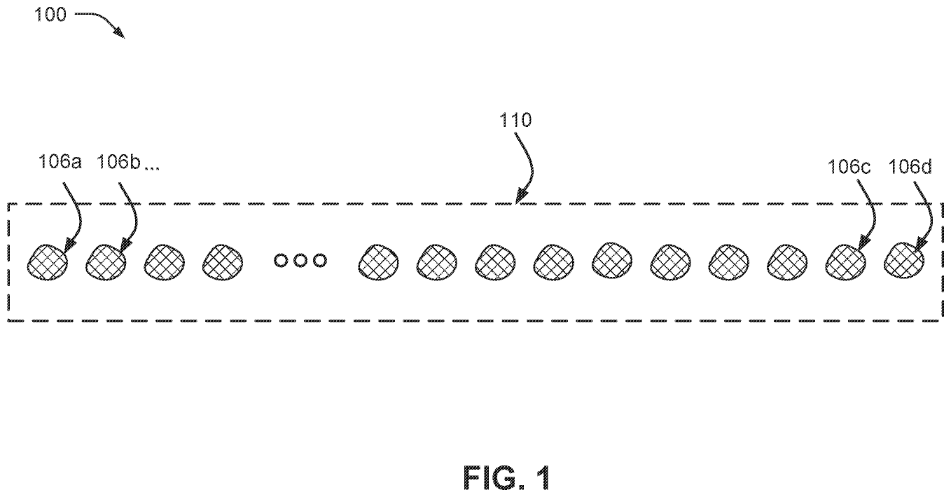

Solutions to the issues described above are explained in more detail in connection with FIGS. 1-9, with FIGS. 1-3 providing a background of QIP systems or quantum computers, and more specifically, of atomic-based QIP systems or quantum computers. This disclosure describes details of geometries for implementing a cryo-compatible (e.g., compatible with a cryogenic environment conditions and temperatures), precision vertical drive with closed-loop positioning capabilities that allows precise motion control for atomic-based QIP systems or quantum computers to operate at improved performances.

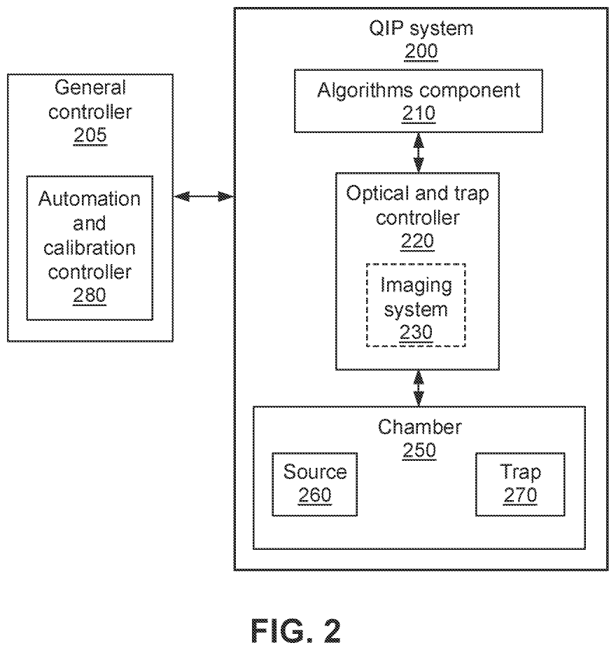

FIG. 1 illustrates a diagram 100 with multiple atomic ions 106 (e.g., atomic ions 106a, 106b, . . . , 106c, and 106d) trapped in a linear crystal or chain 110 using a trap (the trap can be inside a vacuum chamber as shown in FIG. 2). The trap maybe referred to as an ion trap. The ion trap shown may be built or fabricated on a semiconductor substrate, a dielectric substrate, or a glass die or wafer (also referred to as a glass substrate). The atomic ions 106 may be provided to the trap as atomic species for ionization and confinement into the chain 110.

In the example shown in FIG. 1, the trap includes electrodes for trapping or confining multiple atomic ions into the chain 110 that are laser-cooled to be nearly at rest. The number of atomic ions (N) trapped can be configurable and more or fewer atomic ions may be trapped. The atomic ions can be Ytterbium ions (e.g., ¹⁷¹Yb⁺ ions), for example. The atomic ions are illuminated with laser (optical) radiation tuned to a resonance in ¹⁷¹Yb⁺ and the fluorescence of the atomic ions is imaged onto a camera or some other type of detection device. In this example, atomic ions may be separated by about 5 microns (μm) from each other, although the separation may be smaller or larger than 5 μm. The separation of the atomic ions is determined by a balance between the external confinement force and Coulomb repulsion and does not need to be uniform. Moreover, in addition to atomic Ytterbium ions, neutral atoms, Rydberg atoms, different atomic ions or different species of atomic ions may also be used. The trap may be a linear RF Paul trap, but other types of confinement may also be used, including optical confinements. Thus, a confinement device may be based on different techniques and may hold ions, neutral atoms, or Rydberg atoms, for example, with an ion trap being one example of such a confinement device. The ion trap may be a surface trap, for example.

In some instances, to improve operational performance, the chain 110 may be placed inside a cryogenic environment such as the ones described herein.

FIG. 2 shows a block diagram that illustrates an example of a QIP system 200 in accordance with various aspects of this disclosure. The QIP system 200 may also be referred to as a quantum computing system, a quantum computer, a computer device, a trapped ion system, or the like. The QIP system 200 may be part of a hybrid computing system in which the QIP system 200 is used to perform quantum computations and operations and the hybrid computing system also includes a classical computer to perform classical computations and operations.

Shown in FIG. 2 is a general controller 205 configured to perform various control operations of the QIP system 200. Instructions for the control operations may be stored in memory (not shown) in the general controller 205 and may be updated over time through a communications interface (not shown). Although the general controller 205 is shown separate from the QIP system 200, the general controller 205 may be integrated with or be part of the QIP system 200. The general controller 205 may include an automation and calibration controller 280 configured to perform various calibration, testing, and automation operations associated with the QIP system 200.

The QIP system 200 may include an algorithms component 210 that may operate with other parts of the QIP system 200 to perform quantum algorithms or quantum operations, including a stack or sequence of combinations of single qubit operations and/or multi-qubit operations (e.g., two-qubit operations) as well as extended quantum computations. As such, the algorithms component 210 may provide instructions to various components of the QIP system 200 (e.g., to the optical and trap controller 220) to enable the implementation of the quantum algorithms or quantum operations. The algorithms component 210 may receive information resulting from the implementation of the quantum algorithms or quantum operations and may process the information and/or transfer the information to another component of the QIP system 200 or to another device for further processing.

The QIP system 200 may include an optical and trap controller 220 that controls various aspects of a trap 270 in a chamber 250, including the generation of signals to control the trap 270, and controls the operation of lasers and optical systems that provide optical beams that interact with the atoms or ions in the trap. When used to confine or trap ions, the trap 270 may be referred to as an ion trap. The trap 270, however, may also be used to trap neutral atoms, Rydberg atoms, different atomic ions or different species of atomic ions. The lasers and optical systems can be at least partially located in the optical and trap controller 220 and/or in the chamber 250. For example, optical systems within the chamber 250 may refer to optical components or optical assemblies.

The QIP system 200 may include an imaging system 230. The imaging system 230 may include a high-resolution imager (e.g., CCD camera) or other type of detection device (e.g., photomultiplier tube or PMT) for monitoring the atomic ions while they are being provided to the trap 270 and/or after they have been provided to the trap 270. In an aspect, the imaging system 230 can be implemented separate from the optical and trap controller 220, however, the use of fluorescence to detect, identify, and label atomic ions using image processing algorithms may need to be coordinated with the optical and trap controller 220.

In addition to the components described above, the QIP system 200 can include a source 260 that provides atomic species (e.g., a plume or flux of neutral atoms) to the chamber 250 having the trap 270. When atomic ions are the basis of the quantum operations, that trap 270 confines the atomic species once ionized (e.g., photoionized). The trap 270 may be part of a processor or processing portion of the QIP system 200. That is, the trap 270 may be considered at the core of the processing operations of the QIP system 200 since it holds the atomic-based qubits that are used to perform the quantum operations or simulations. At least a portion of the source 260 may be implemented separate from the chamber 250.

It is to be understood that the various components of the QIP system 200 described in FIG. 2 are described at a high-level for ease of understanding. Such components may include one or more sub-components, the details of which may be provided below as needed to better understand certain aspects of this disclosure.

For example, at least parts of the chamber 250 may operate under cryogenic conditions. In one example, the chamber 250 may be a cryostat or comprise a cryostat to provide specific cryogenic conditions. The chamber 250 may support multiple stages. For example, the chamber 250 may include a first stage or first environment at 40 Kelvin, and a second stage or second environment at 4 Kelvin positioned within the first stage.

A vertical nanopositioner for use with high loads and in cryogenic environments is described herein. Example high loads include loads weighing between 1 kilogram (kg) and 5 kg. In some aspects, the loads may include one or more optical components. In an example aspect, the vertical nanopositioner 400 may be positioned within the chamber 250 and can be configured to move or align different components within the chamber 250, including optical components.

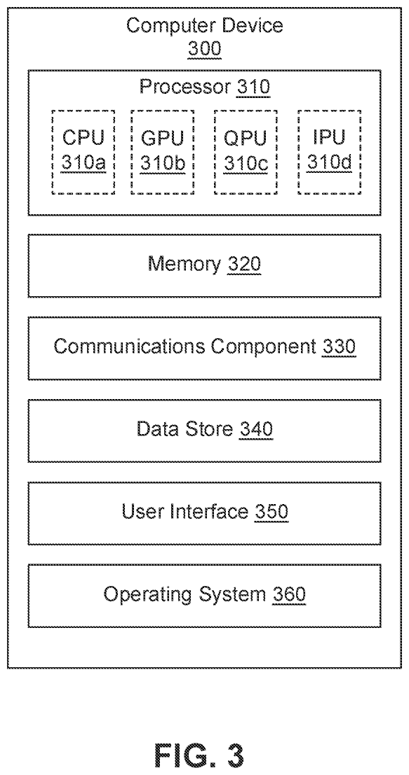

Referring now to FIG. 3, illustrated is an example of a computer system or device 300 in accordance with aspects of the disclosure. The computer device 300 can represent a single computing device, multiple computing devices, or a distributed computing system, for example. The computer device 300 may be configured as a quantum computer (e.g., a QIP system), a classical computer, or to perform a combination of quantum and classical computing functions, sometimes referred to as hybrid functions or operations. For example, the computer device 300 may be used to process information using quantum algorithms, classical computer data processing operations, or a combination of both. In some instances, results from one set of operations (e.g., quantum algorithms) are shared with another set of operations (e.g., classical computer data processing). A generic example of the computer device 300 implemented as a QIP system capable of performing quantum computations and simulations is, for example, the QIP system 200 shown in FIG. 2.

The computer device 300 may include a processor 310 for carrying out processing functions associated with one or more of the features described herein. The processor 310 may include a single or multiple set of processors or multi-core processors. Moreover, the processor 310 may be implemented as an integrated processing system and/or a distributed processing system. The processor 310 may include one or more central processing units (CPUs) 310a, one or more graphics processing units (GPUs) 310b, one or more quantum processing units (QPUs) 310c, one or more intelligence processing units (IPUs) 310d (e.g., artificial intelligence or AI processors), or a combination of some or all those types of processors. In one aspect, the processor 310 may refer to a general processor of the computer device 300, which may also include additional processors 310 to perform more specific functions (e.g., including functions to control the operation of the computer device 300).

The computer device 300 may include a memory 320 for storing instructions executable by the processor 310 to carry out operations. The memory 320 may also store data for processing by the processor 310 and/or data resulting from processing by the processor 310. In an implementation, for example, the memory 320 may correspond to a computer-readable storage medium that stores code or instructions to perform one or more functions or operations. Just like the processor 310, the memory 320 may refer to a general memory of the computer device 300, which may also include additional memories 320 to store instructions and/or data for more specific functions.

It is to be understood that the processor 310 and the memory 320 may be used in connection with different operations including but not limited to computations, calculations, simulations, controls, calibrations, system management, and other operations of the computer device 300, including any methods or processes described herein.

Further, the computer device 300 may include a communications component 330 that provides for establishing and maintaining communications with one or more parties utilizing hardware, software, and services. The communications component 330 may also be used to carry communications between components on the computer device 300, as well as between the computer device 300 and external devices, such as devices located across a communications network and/or devices serially or locally connected to computer device 300. For example, the communications component 330 may include one or more buses, and may further include transmit chain components and receive chain components associated with a transmitter and receiver, respectively, operable for interfacing with external devices. The communications component 330 may be used to receive updated information for the operation or functionality of the computer device 300.

Additionally, the computer device 300 may include a data store 340, which can be any suitable combination of hardware and/or software, which provides for mass storage of information, databases, and programs employed in connection with the operation of the computer device 300 and/or any methods or processes described herein. For example, the data store 340 may be a data repository for operating system 360 (e.g., classical OS, or quantum OS, or both). In one implementation, the data store 340 may include the memory 320. In an implementation, the processor 310 may execute the operating system 360 and/or applications or programs, and the memory 320 or the data store 340 may store them.

The computer device 300 may also include a user interface component 350 configured to receive inputs from a user of the computer device 300 and further configured to generate outputs for presentation to the user or to provide to a different system (directly or indirectly). The user interface component 350 may include one or more input devices, including but not limited to a keyboard, a number pad, a mouse, a touch-sensitive display, a digitizer, a navigation key, a function key, a microphone, a voice recognition component, any other mechanism capable of receiving an input from a user, or any combination thereof. Further, the user interface component 350 may include one or more output devices, including but not limited to a display, a speaker, a haptic feedback mechanism, a printer, any other mechanism capable of presenting an output to a user, or any combination thereof. In an implementation, the user interface component 350 may transmit and/or receive messages corresponding to the operation of the operating system 360. When the computer device 300 is implemented as part of a cloud-based infrastructure solution, the user interface component 350 may be used to allow a user of the cloud-based infrastructure solution to remotely interact with the computer device 300.

In connection with the systems described in FIGS. 1-3, below are described details regarding geometries for implementing and operating cryo-compatible precision vertical drives with closed-loop positioning.

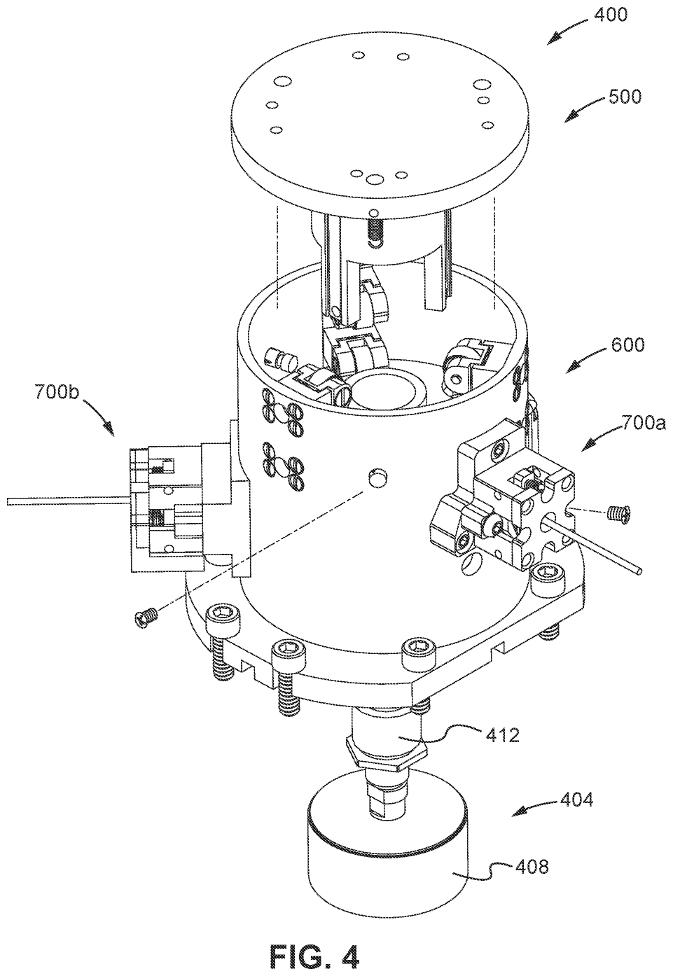

FIG. 4 illustrates an example of an exploded view of a cryo-compatible vertical nanopositioner assembly 400. The example nanopositioner assembly 400 is configured to reposition relatively high loads, for example loads weighing between 1 kg and 5 kg. The loads may include one or more optical components. The nanopositioner assembly 400 includes a first or upper stage 500 and a second or lower stage 600 coupled to a motorized lead screw 404. As described in greater detail below, the motorized lead screw 404 is configured to reposition a movable platform 504 of the upper stage 500. As is described in greater detail below, one or more interferometer sensor assemblies 700 may be coupled to the lower stage 600. The one or more interferometer assemblies may be configured to determine a position of the upper stage 500 relative to the lower stage 600.

As is shown in FIGS. 4, 8, and 9, the motorized lead screw 404 includes a motor 408, a bushing 412 including a nut, and a threaded shaft or screw 416. The nut and the threaded shaft 416 are threadably engaged. The motor 408 is configured to rotate the nut (not shown) or the threaded shaft 416 to extend or retract the threaded shaft 416. The threaded shaft 416 is engaged with the upper stage 500 to actuate motion of the upper stage 500 relative to the lower stage 600 with precision and stability. For example in some example aspects, a minimum step size of the motor 408 may be about 0.6 nm. In such an aspect, a maximum diameter of the treaded shaft may be about 13 mm, a minimum pitch of the lead screw pitch may be about 0.25 mm, and a minimum step size of the motor piezo may be about 100 mm. The motorized lead screw 404 is configured to continuously position (or reposition) the upper stage 500 between a first position in which the threaded shaft 416 is fully retracted and a second position in which the threaded shaft 416 is fully extended. The motorized lead screw 404 is configured so that the motorized lead screw 404 can reposition loads weighing between 1 kilogram (kg) and 5 kg.

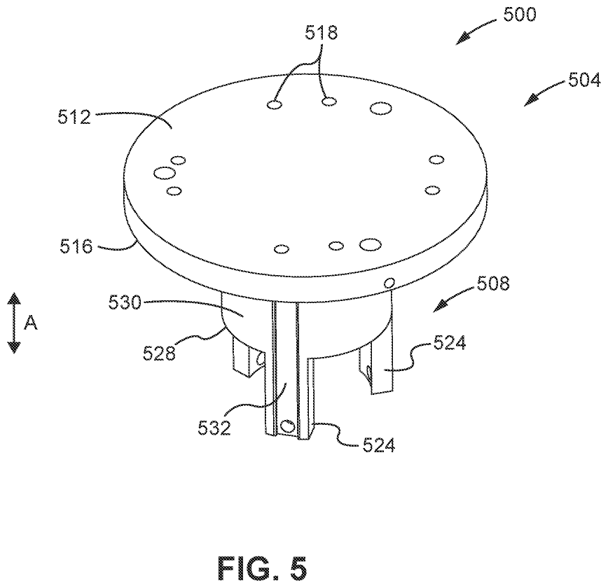

FIG. 5 illustrates an example of the first or upper stage 500 of the vertical nanopositioner assembly 400. The upper stage 500 includes the movable platform 504 and a hollow shaft 508. The movable platform 504 includes a first surface 512 and a second surface 516 opposite the first surface 512. A plurality of mounting features 518 are positioned on the movable platform 504. In some aspects, the mounting features 518 may include one or more through openings. One or more hardware components may be coupled to the movable platform 504 via the mounting features 518. Example hardware components may include optical components that may need to be moved and/or aligned during operation of the QIP System 200.

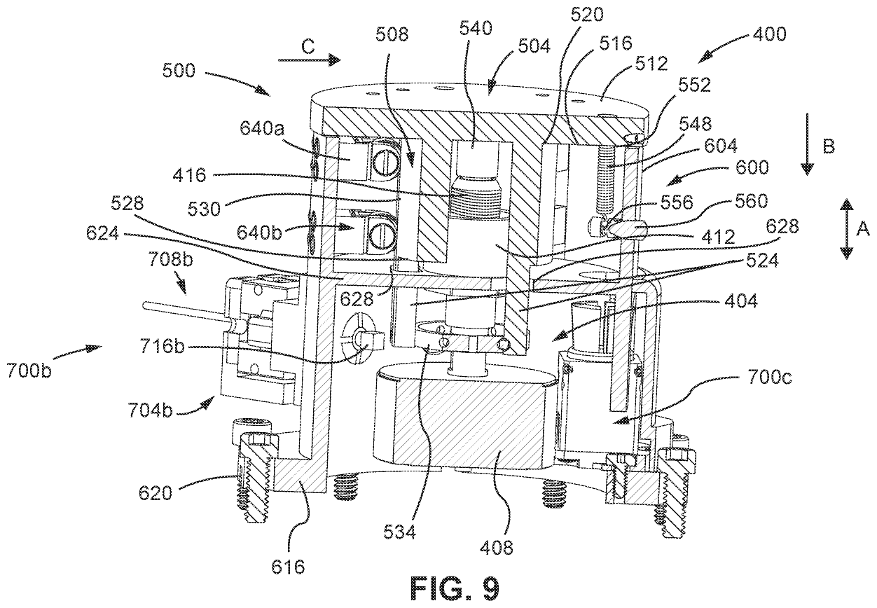

A first end 520 (FIG. 9) of the hollow shaft 508 extends from the second surface 516 of the movable platform 504. A plurality of alignment features 524 extend from a second end 528 of the hollow shaft 508. A plurality of guide tracks 532 extend along an outer surface 530. As described in greater detail below, the guide tracks 532 are configured to receive roller bearings 640 coupled to the lower stage 600. The free ends of the alignment features 524 are coupled to an annular ring 534. In some aspects, the annular ring 534 may be a mechanical end stop. As shown in FIG. 5, in some aspects, the plurality of alignment features 524 includes three alignment features. In other aspects, the plurality of alignment features 524 may include more or fewer alignment features. In some aspects, the alignment features 524 are substantially evenly positioned about a circumference of the hollow shaft 508. For example, in the configuration illustrated in FIG. 5, the alignment features 524 are spaced 120 degrees apart about the circumference of the hollow shaft 508. As shown in FIG. 5, in some aspects, the plurality of guide tracks 532 includes three guide tracks. In other aspects, the plurality of guide tracks 532 may include more or fewer guide tracks.

The hollow shaft 508, the alignment features 524, and the guide tracks 532 are configured to substantially restrict motion of the upper stage 500 to the direction indicated by the Arrow A. The hollow shaft 508, the alignment features 524, and the guide tracks 532 are configured to substantially maintain the first surface 512 of the movable platform 504 substantially perpendicular to the direction of motion indicated by the Arrow A as the upper stage 500 is positioned or repositioned by the motorized lead screw 404.

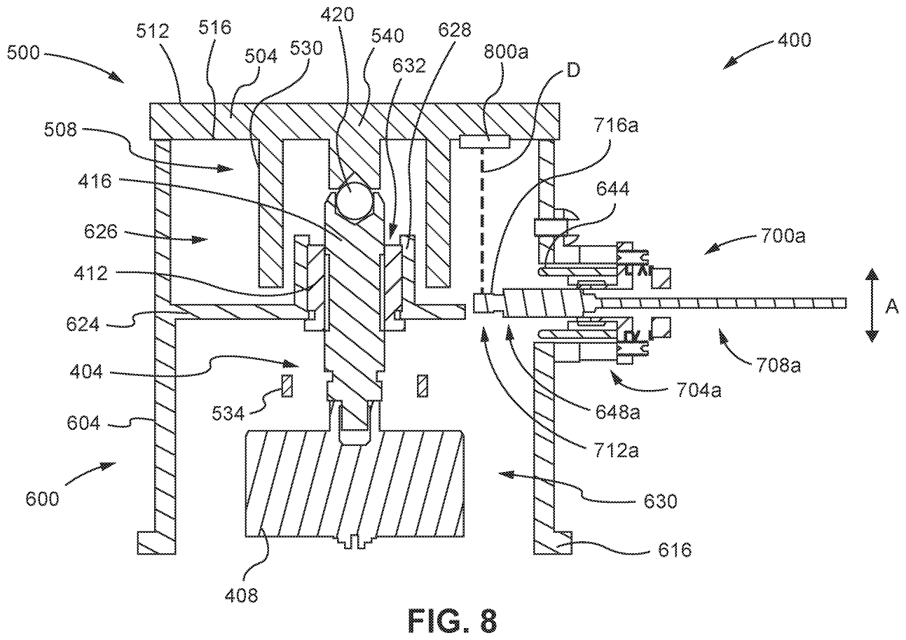

As shown in FIGS. 8-9, a boss 540 extends from the second surface 516 of the movable platform 504 at or proximate a center of the second surface 516. The boss 540 is positioned within the hollow shaft 508 and is concentric within the hollow shaft 508. As described in greater detail below, the boss 540 is configured to engage the motorized lead screw 404. In some aspects, the boss 540 includes a curved recess 544 configured to engage a ball tip 420 of the motorized lead screw 404. In some aspects, the curved recess 544 may be conical.

As shown in FIG. 9, a plurality of springs 548 may be coupled between the upper stage 500 and the lower stage 600. For example, a first end 552 of each of the springs 548 may be coupled to the second surface 516 of the movable platform 504. A second end 556 of each of the springs 548 may be coupled to the lower stage 600 and/or a component coupled to the lower stage 600. For example, in the configuration illustrated in FIG. 9, the second end 556 of the spring 548 is coupled to a mounting pin 560 coupled to the lower stage 600. The springs 548 may be configured to bias or urge the upper stage 500 in the direction indicated by Arrow B. The bias of the springs 548 may cause the upper stage 500 to remain in contact with the lower stage 600 as the motorized lead screw 404 is actuated to move the upper stage 500 in the vertical direction indicated by the Arrow A. The bias of the springs 548 maintains engagement of the upper stage 500 with the lower stage 600 over the entire range of motion (e.g. between fully extended, fully retracted, and intermediate positions therebetween) regardless of the load on the lead screw 404.

In some aspects, the plurality of springs 548 includes three springs. In other aspects, the plurality of springs 548 may include more or fewer springs. In some aspects, the springs 548 are substantially evenly positioned about a circumference of the lower stage 600. For example, in some aspects, the springs 548 are spaced 120 degrees apart about the circumference of the lower stage 600.

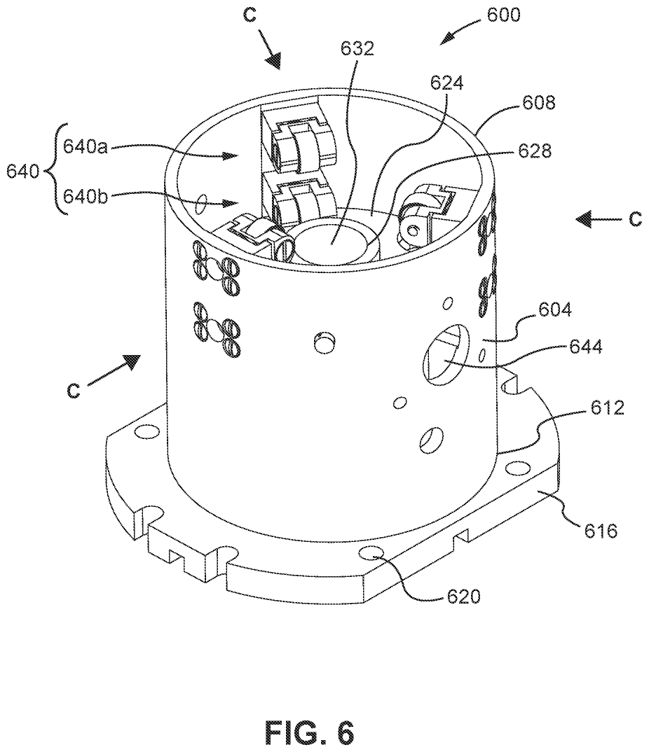

FIG. 6 illustrates an example of the lower or second stage 600 of the vertical nanopositioner assembly 400. The lower stage 600 includes a substantially cylindrical body 604. A first end 608 of the body 604 is configured to engage the upper stage 500 of the vertical nanopositioner assembly 400. A second end 612 of the body includes a flange 616. The flange 616 may include one or more mounting features 620. The lower stage 600 may be coupled to a surface, such as a first or second stage of a cryostat, via the mounting features 620.

As shown in FIGS. 8-9, a planar coupling member 624 is positioned within the body 604, which can, for example, be based on the length of lead screw 404 and the desired range of the device. The planar coupling member 624 may define a first or upper cavity 626 of the body 604 and a second or lower cavity 630 of the body 604. In some aspects, the first and second cavities 626, 630 may be collectively referred to as a cavity defined by the body 603. The planar coupling member 624 includes a protrusion 628 defining a channel 632. The channel 632 is positioned at a center of the planar coupling member 624. The protrusion 628 and the channel 632 are configured to receive the motorized lead screw 404 therethrough. In the illustrated aspect, the bushing 412 of the motorized lead screw 404 is fixedly coupled to the inner walls of the protrusion 628.

The planar coupling member 624 includes a plurality of openings 636 (FIG. 9) positioned concentrically about the protrusion 628. In some aspects, the plurality of openings 636 includes three openings. In other aspects, the plurality of openings 636 may include more or fewer openings. In some aspects, the openings 636 are substantially evenly positioned about a circumference of protrusion 628. For example, in some aspects, the openings 636 are spaced 120 degrees apart about the circumference of the protrusion 628.

As shown in FIG. 9, when the upper stage 500 is engaged with the lower stage 600, the protrusion 628 is received within the hollow shaft 508. Each of the alignment features 524 is received within a corresponding one of the openings 636. The orientations of the protrusion 628, the hollow shaft 508, the alignment features 524, and the openings 636 cooperate to maintain motion of the upper stage 500 in the direction indicated by the Arrow A.

A plurality of roller bearings 640 are coupled to the inner walls of the body 604 such that the roller bearings 640 extend into the upper cavity 626. The upper stage 500 is preloaded relative to the lower stage 600 to compensate for any gaps that develop between the upper stage 500 and the lower stage 600 due to, for example, thermal contraction as the vertical nanopositioner assembly 400 is cooled to cryogenic temperatures. In some aspects, the roller bearings 640 are spring-loaded roller bearings. The roller bearings 640 are configured to maintain alignment of the upper stage 500 relative to the lower stage 600 over large temperature ranges. For example, the roller bearings 640 may be configured to maintain alignment of the upper stage 500 relative to the lower stage 600 during the transition from room temperature, e.g., approximately 300 K to cryogenic temperatures such as the 40 K temperature of the first cryogenic stage and/or the 4 K temperature of the second cryogenic stage. For example, the roller bearings 640 may be configured to maintain alignment and engagement with the upper stage 500 (e.g., via the hollow shaft 508, the alignment features 524, and/or the guide tracks 532) without jamming or loosening during temperature transitions across large temperature ranges and involving components including materials having various coefficients of thermal expansion.

In such aspects, the spring-loaded roller bearings 640 are biased in the radially inward direction as indicated by the arrow C. As shown in FIG. 9, the roller bearings 640 contact the perimeter of the hollow shaft 508 when the upper stage 500 is engaged with the lower stage 600. The springs of the spring-loaded roller bearings 640 maintain contact between the spring-loaded roller bearings 640 and the hollow shaft 508. Each of the roller bearings 640 is engaged with one of the guide tracks 532 of the alignment features 528. The forces applied on the hollow shaft 508 by the roller bearings 640 (e.g., shown by Arrow C) maintain alignment of the hollow shaft 508 relative to a longitudinal axis of the motorized lead screw 404 and the protrusion 628 as the motorized lead screw 404 moves within the channel 632 of the protrusion 628 and the hollow shaft 508. The forces applied on the hollow shaft 508 by the roller bearings 640 may also prevent wobbling of the movable platform 504 as the motorized lead screw 404 moves the upper stage 500 relative to the lower stage 600.

In some aspects, the plurality of roller bearings 640 includes six roller bearings. In other aspects, the plurality of roller bearings 640 may include more or fewer roller bearings. In the configuration illustrated in FIG. 6, a first portion of the roller bearings 640 is arranged in a first ring 640a and a second portion of the roller bearings 640 is arranged in a second ring 640b. In some aspects, the roller bearings 640 are substantially evenly positioned about a circumference of the body 604 such that the roller bearings 640 can exert a substantially even force about the circumference of the hollow shaft 508 when the upper stage 500 is engaged with the lower stage 600. For example, in the configuration illustrated in FIG. 6, the roller bearings 640 in each of the first and second rings 640a, 640b are spaced about 120 degrees apart about the interior of the body 604. In this example, the roller bearings 610 in each of the first and second 640a, 640b are configured to engage portions of the circumference of the hollow shaft 508 that are about 120 degrees apart. The first ring and second ring 640a, 640b may be positioned relative to the hollow shaft 508 and the alignment features 528 such that the roller bearings 640 are configured to apply forces along substantially an entire length of the hollow shaft 508 and/or alignment features 528 that is positioned in the upper cavity 626 of the body 604. The first ring and second ring 640a, 640b may be positioned within the upper cavity 626 at heights configured to prevent interference or disengagement of the roller bearings 640 with the hollow shaft 508 or the alignment features 528 when the upper stage 500 is the first position (e.g., the threaded shaft 416 is fully retracted) or the second position (e.g., the threaded shaft 416 is fully extended).

In the example aspect, the roller bearings 640 are made of ceramic material having a low coefficient of thermal expansion and a high compressive strength. Such material properties allow for smooth rotation and a reduced likelihood of jamming at very cold temperatures. In some aspects, the roller bearings 640 may include silicon nitride, zirconium oxide, and/or silicon carbide. In some aspects the coefficient of thermal expansion of the material of the roller bearings 640 is from about 2×10⁻⁶/K to about 4×10⁻⁶/K.

Still referring to FIG. 9, the motor 487 and a portion of the bushing 412 of the motorized lead screw 404 are positioned in the lower cavity 630 of the body 604. As described in greater detail below, one or more interferometer sensor assemblies 700 may be at least partially positioned in the lower cavity 63 of the body 604.

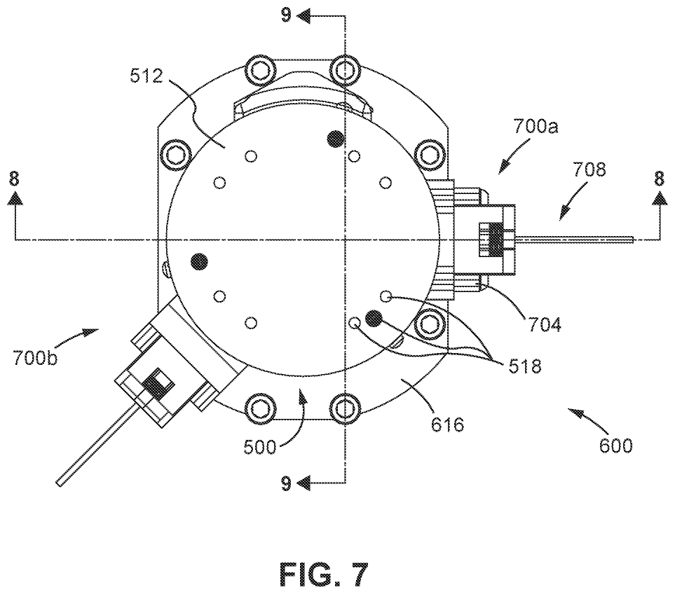

As shown in FIG. 7, in the illustrated aspect of the nanopositioner assembly 400, a first interferometer sensor assembly 700a and a second interferometer sensor assembly 700b are coupled to the body 604 of the lower stage 600. The interferometer sensor assemblies 700a, 700b are substantially similar to each other, so only the interferometer sensor assembly 700a is described in detail below. The interferometer sensor assembly 700a includes a housing 704a and a sensor body 708a. FIG. 8 is a section view of the nanopositioner assembly 400 taken along lines 8-8 of FIG. 7. The section line 8-8 substantially bisects the interferometer sensor assembly 700a.

As shown in FIG. 8, the housing 704a is coupled to the body 604 such that the housing 704a and the sensor body 708a are aligned with an opening 644 (FIGS. 6 and 8) on the body 604. In some aspects, the housing 704a may be coupled to the body 604 via one or more fasteners. The opening 644 is configured to allow a portion of the sensor body 708a to extend into the interior of the body 604. A first end 712a of the sensor body 708a extends into an opening 648a of the planar coupling member 624. The sensor body 708a is positioned within the opening 648a such that an interferometer sensor head 716a is substantially aligned with a reflective target 800a coupled to the second surface 516 of the movable platform 504, as shown by the line D. The interferometer sensor assembly 700a is configured to determine a distance between the target 800a and the interferometer sensor head 716a. In some aspects, the interferometer sensor assembly 700a is configured to determine distances at resolutions of less than 1 micron (μm). In some aspects, the interferometer sensor assembly 700a is configured to determine distances at resolutions of about 5 nm to about 10 nm. In some aspects, the interferometer sensor assembly 700 is configured to determine distances of less than 10 nm In some aspects, the interferometer sensor assembly 700a is configured to determine distances at resolutions of less than 1 nanometer. In some aspects, the interferometer sensor assembly 700a is configured to determine distances at resolutions of about 10 picometers (pm) to about 100 pm. In configurations that include more than one interferometer sensor assembly 700, second surface 516 of the movable platform 504 includes a target 800 aligned with each of the interferometer sensor assemblies 700.

As shown in FIG. 8, the sensor body 780a is positioned at substantially the same height along the body 604 as the planar coupling member 624. In other configurations, such as for the interferometer sensor assembly 700b, the interferometer sensor housing 704b may be coupled to a position along the body 604 that is below the planar coupling member 624. In such aspects, the sensor body 708b is positioned such that the interferometer sensor head 716b is aligned with an opening 648b in the planar coupling member 624 such that the interferometer sensor head 716b can determine a distance between the interferometer sensor head 716b and a reflective target 800 positioned on the second surface 516 of the movable platform 504.

In the illustrated construction, the nanopositioner assembly 400 includes at least two interferometer sensor assemblies 700a, 700b. In constructions that include at least the sensors to measure the position of the movable platform 504, any angular misalignment, such as, for example, any pitch/tilt on of the movable platform 504 relative to the lead screw 404 can be measured and calibrated in firmware.

Since a portion of the body 604 is defined as a fixed reference point of the nanopositioner assembly 400, the interferometer sensor assemblies 700 provide non-contact, displacement measurements of the movable platform 504. In some aspects, data determined by the interferometer sensor assemblies 700a, 700b can be used for closed loop positional control. For example, the controller (e.g., the general controller 204 and/or the optical and trap controller 220) be configured to determine, based on the data determined by the interferometer sensor assemblies 700a, 700b, whether optical components coupled to the movable platform 504 are aligned relative to other components of the QIP system 200. In some aspects, controller 204, 220 may be configured to maintain the movable platform 504 at a predefined position based on feedback data from external (or built-in) sensors. In some aspects, controller 204, 220 may be configured to position or reposition the movable platform 504 in response to data from external (or built-in) sensors until certain parameters are achieved. For example, in aspects, a lens may be coupled to the movable platform 504. In such aspects, the position of the movable platform may be adjusted until a camera system measuring light travelling through the lens achieved a target value. Most commercial nanopositioners do not integrate sensors for closed-loop motion. Those that do often employ resistive linear sensors, which cannot achieve resolutions better than 1 μm or accuracies better than 5 μm, and only measure relative displacements. In some aspects, the interferometer sensor assembly integrated into this design has nanometer resolution (e.g., can determine resolutions below 1 μm). In some aspects, the interferometer sensor assembly integrated into this design has picometer resolution (e.g., can determine resolutions below 1 nm). In some aspects, interferometer sensor assembly has absolute measurement ability that is robust to power cycling of the device. In contrast, a relative position sensors, which are conventionally used in positioning devices, need to rehome and reset its position after losing power, which adds limits to its operational modality.

In some aspects, a controller, such as the general controller 205 or an optical system controller, may be configured to receive information indicative of the determined distance between the target and the interferometer sensor head from the interferometer sensor assembly. The controller may be configured to compare the determined difference to a predefined target. The predefined target may include a position or range of positions at which optical component(s) coupled to the first stage 500 are aligned with a laser beam. The controller may be configured to actuate the motor 408 of the motorized lead screw 404 to reposition the first stage 500 in response to the comparison indicating that the determined difference is above or below the predefined target.

The previous description of the disclosure is provided to enable a person skilled in the art to make or use the disclosure. Various modifications to the disclosure will be readily apparent to those skilled in the art, and the common principles defined herein may be applied to other variations without departing from the scope of the disclosure. Furthermore, although elements of the described aspects may be described or claimed in the singular, the plural is contemplated unless limitation to the singular is explicitly stated. Additionally, all or a portion of any aspect may be utilized with all or a portion of any other aspect, unless stated otherwise. Thus, the disclosure is not to be limited to the examples and designs described herein but is to be accorded the widest scope consistent with the principles and novel features disclosed herein.

What is claimed is:

1. A quantum information processing (QIP) system comprising:
a nanopositioner configured to reposition one or more components coupled to the nanopositioner, wherein the one or more components weigh between about 1 kilogram (kg) and about 5 kgs; and
a cryogenic environment, wherein the nanopositioner is positioned in the cryogenic environment.

2. The QIP system of claim 1, comprising a cryostat comprising the cryogenic environment within which the nanopositioner is positioned.

3. The QIP system of claim 1, wherein the nanopositioner is configured to reposition the one or more components with a resolution of less than one micron.

4. The QIP system of claim 1, wherein the nanopositioner comprises:
a first stage comprising mounting features configured to engage the one or more components;
a second stage; and
a lead screw coupled to the first stage and the second stage and configured to reposition the first stage relative to the second stage.

5. The QIP system of claim 4, wherein the first stage comprises a first surface adjacent the one or more components and a second surface opposite the first surface, the second surface comprising a hollow protrusion configured to receive the lead screw; and
wherein the second stage comprises a substantially cylindrical body defining a hollow cavity and a plurality of roller bearings coupled to the substantially cylindrical body and extending into the hollow cavity, the plurality of roller bearings configured to engage the hollow protrusion and maintain alignment of the first stage relative to an axis defined by the lead screw.

6. The QIP system of claim 5, wherein the plurality of roller bearings include at least one of silicon nitride, zirconium oxide, silicon carbide, or combinations thereof.

7. The QIP system of claim 5, wherein the plurality of roller bearings have a coefficient of thermal expansion from about 2×10⁻⁶/K to about 4×10⁻⁶/K.

8. The QIP system of claim 5, wherein the plurality of roller bearings are configured to maintain the alignment of the first stage relative to the axis defined by the lead screw during a temperature transition from about 300 Kelvin (K) to about 40 K.

9. The QIP system of claim 4, wherein the first stage comprises a first surface adjacent the one or more components and a second surface opposite the first surface, the second surface comprising a target and a hollow protrusion configured to receive the lead screw; and
wherein an interferometer sensor assembly including an interferometer sensor head is coupled to the second stage and configured to determine a distance between the target and the interferometer sensor head.

10. The QIP system of claim 9, wherein the interferometer sensor head is configured to determine the distance between the target and the interferometer sensor head at the nanometer scale.

11. The QIP system of claim 9, further comprising a controller comprising a processor and a memory, the memory including instructions executable by the processor to:
receive information indicative of the determined distance between the target and the interferometer sensor head from the interferometer sensor assembly;
compare the determined difference to a predefined target; and
actuate a motor coupled to the lead screw to reposition the first stage in response to the comparison indicating that the determined difference is above or below the predefined target.

12. The QIP system of claim 11, wherein the one or more components coupled to the nanopositioner comprise one or more optical components and wherein the predefined target is configured to be aligned with a laser beam.

13. A nanopositioner configured to operate in a cryogenic environment, the nanopositioner comprising:
a first stage coupled to one or more optical components, wherein the one or more optical components weigh about 1 kilogram (kg) to about 5 kg;
a second stage configured to engage a support surface; and
a lead screw engaged with the first stage and the second stage and configured to reposition the first stage relative to the second stage.

14. The nanopositioner of claim 13, wherein the lead screw is configured to continuously position the first stage from a first position, in which the first stage is adjacent the second stage and a second position in which the first stage is spaced from the second stage.

15. The nanopositioner of claim 14, further comprising one or more springs coupled to the first stage and the second stage and configured to bias the first stage towards the first position.

16. The nanopositioner of claim 13, wherein the first stage comprises a first surface adjacent the one or more optical components and a second surface opposite the first surface, the second surface comprising a hollow protrusion configured to receive the lead screw; and
wherein the second stage comprises a substantially cylindrical body defining a hollow cavity and a plurality of roller bearings coupled to the substantially cylindrical body and extending into the hollow cavity, the plurality of roller bearings configured to engage the hollow protrusion and maintain alignment of the first stage relative to an axis defined by the lead screw.

17. The nanopositioner of claim 16, wherein an outer surface of the hollow protrusion comprises a plurality of guide tracks configured to receive the plurality of roller bearings.

18. The nanopositioner of claim 16, wherein each roller bearing of the plurality of roller bearings is coupled to a spring configured to urge the roller bearing into engagement with the hollow protrusion of the first stage.

19. The nanopositioner of claim 16, wherein the plurality of roller bearings are configured to maintain the alignment of the first stage relative to the axis defined by the lead screw during a temperature transition from about 300 Kelvin (K) to about 40 K.

20. The nanopositioner of claim 13, wherein the first stage comprises a first surface adjacent the one or more optical components and a second surface opposite the first surface, the second surface comprising a target and a hollow protrusion configured to receive the lead screw; and
wherein at least one interferometer sensor assembly including an interferometer sensor head is coupled to the second stage and configured to determine a distance between the target and the interferometer sensor head.
